(19) United States
(12) Patent Application Publication
(10) Pub. No.: US 2016/0377024 A1
(43) Pub. Date: Dec. 29, 2016

(54) Condensing Stirling Cycle Heat Engine

(71) Applicant: Matthew David Marko, Seaside Heights, NJ (US)

(72) Inventor: Matthew David Marko, Seaside Heights, NJ (US)

(73) Assignee: Matthew David Marko, Lakehurst, NJ (US)

(21) Appl. No.: 15/260,353

(22) Filed: Sep. 9, 2016

(51) Int. Cl. F02G 1/043

(52) U.S. Cl. CPC F02G 1/043; F02G 2243/30; F02G 2250/00

(57) ABSTRACT

The inventor claims a heat engine that follows a modification of the Stirling thermodynamic heat engine cycle; the novel aspect is that the monatomic working fluid is a saturated gas at the beginning of the isothermal compression stage, and ends up a mixed-phase fluid at the end of the compression. This cycle takes advantage of the attractive intermolecular forces of the working fluid to assist in compressing the working fluid partially into a liquid, reducing the input compression work and increasing the overall heat engine efficiency.

### BACKGROUND OF THE INVENTION

From well before recorded human history, man has quested for different sources of energy for survival and comfort. Today, the need for useful energy plays a role in almost all aspects of society. Certainly, there is a benefit to having an efficient source of mechanical energy. When designing an engine, heat pump, or other thermodynamic cycle, one can not get around the laws of thermodynamics. Prevalent is the first law, which stipulates the conservation of energy; no energy can be created or destroyed. The second law is a result of the fact that heat can only flow from hot to cold, and not cold to hot; as a result, heat transfer processes ultimately result in thermodynamic disorder known as entropy throughout the universe. These two natural limitations have to be recognized in the design of a thermodynamic machine to achieve a net mechanical work output.

Under dense, pressurized conditions, a fluid ceases to become an ideal gas, and becomes a real gas following its equation of state. At a certain point, the intermolecular attractive forces of the fluid causes the gas to condense to a liquid, where these forces are too much for the kinetic energy of the fluid molecules to overcome, and the particles converge into a more ordered liquid state. During condensation, the fluid exists at two distinct phases at a constant temperature and pressure until it is a single consistent phase. As the pressure is constant with reduced volume during condensation, the intermolecular forces will reduce the work input during condensation from a saturated gas to a mixed-phase fluid.

### BRIEF SUMMARY OF THE INVENTION

The inventor proposes a closed-loop, internally reversible, piston-cylinder heat engine, not dissimilar to the Stirling cycle. Rather than use an ideal gas, this cycle uses a real fluid that partially condenses during the isothermal compression stage of the cycle. The isothermal compression phase starts off as a saturated gas, and compresses isothermally at the cool temperature until a percentage of the gas has condensed. It then is heated to the hot temperature isochorically, at a temperature greater than the critical temperature. Afterwards, it expands isothermally back to the original saturated gas volume, recovering energy in the process. Finally, the gas is cooled isochorically back to the original stage pressure and temperature, where it is a saturated gas.

The engine takes advantage of the fluid's intermolecular attractive forces that enable the fluid to condense into a liquid. The impact of these forces is profound during condensation when the fluid is stable as two distinct phases of liquid and gas, as described by Maxwell's Construction. These forces keep the pressure consistent throughout condensation, rather than increasing with reduced volume as would be described during the equation of state; this ultimately results in less work input to compressed the gas isothermally, and thus greater efficiency of the heat engine.

### BRIEF DESCRIPTION OF THE FIGURES

FIG. 1 The labile Van der Waal isotherm (solid line), and the stable Maxwell's Construction (thick dashed curve), for a reduced temperature T_{R}=0.90. The thin line represents the phase change as determined with Maxwell's construction for a reduced VDW equation of state.

FIG. 2 The Pv diagram of this modified Stirling cycle heat engine, for a low reduced temperature of T_{R}=0.8, and a high reduced temperature of T_{R}=1.1. The thin line represents the phase change as determined with Maxwell's construction for a reduced VDW equation of state.

FIG. 3 The reduced internal energy during condensation, using both the (dashed line) VDW derived equation 21, as well as the partial summation of the liquid and gas reduced internal energy under Maxwell's Construction (equation 9), as a function of quality χ, and for a reduced temperature of T_{R}=0.8.

FIG. 4 The entropy increase, determined numerically, from heating the mixed phase fluid at a reduced temperature of T_{R}=−0.8 and a quality χ−0.1890, to a super-critical gas at a reduced temperature of T_{R}'1.1. The diamond marker points out the point, determined to be at T_{R}=0.9930, when the fluid is entirely a super-heated gas, before it becomes super-critical past T_{R}=1. The total reduced entropy is δs_{R}=1.7487 at T_{R}=1.1.

FIG. 5 The condensing Stirling Cycle Engine, Stage 1, where the working fluid argon is at the low temperature of 120 K, and the piston is at Bottom Dead Center. The argon is a saturated gas at this stage.

FIG. 6 The condensing Stirling Cycle Engine, Stage 2, where the working fluid argon is at the low temperature of 120 K, and the piston is at Top Dead Center. The argon is a mixed phase liquid-gas mixture, with a quality of 10%.

FIG. 7 The condensing Stirling Cycle Engine, Stage 3, where the working fluid argon is at the high temperature of 166 K, and the piston is at Top Dead Center. The argon is a super-critical gas under very high pressure.

FIG. 8 The condensing Stirling Cycle Engine, Stage 4, where the working fluid argon is at the high temperature of 166 K, and the piston is at Bottom Dead Center. The argon is a super-critical gas under moderate pressure.

FIG. 9 The gear system to operate the ideal-gas temperature adjusting piston. The mechanism is identical to the condensing Stirling Cycle engine; substitute Part I for M, Part J for N, Part K for O, and Part L for P. This piston is to remain fixed during this 90° range, so the mutilated gear has no tooths, and the cam system pushes a plunger up, to fix the gear in place. This cam system prevents the gear from flowing open during this stage.

FIG. 10 The gear system to operate the ideal-gas temperature adjusting piston. The mechanism is identical to the condensing Stirling Cycle engine; substitute Part I for M, Part J for N, Part K for O, and Part L for P. This piston is to move during this 90° range, so the mutilated gear has tooths, and the cam system is depressed allowing the gear to freely spin.

### Heat Pump Components

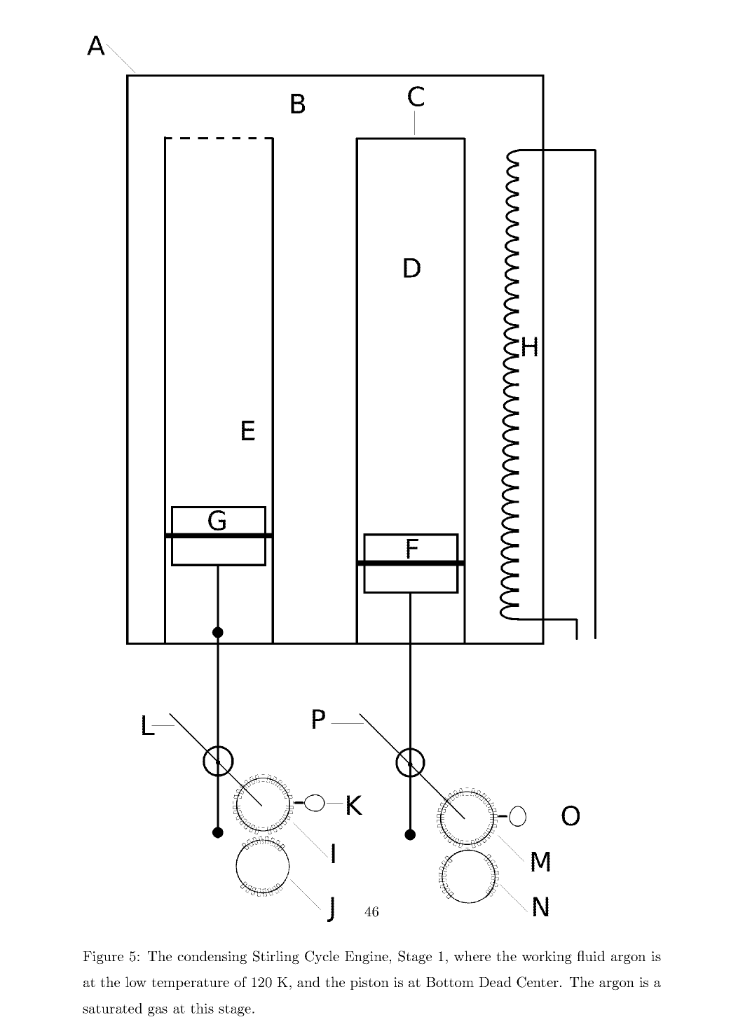

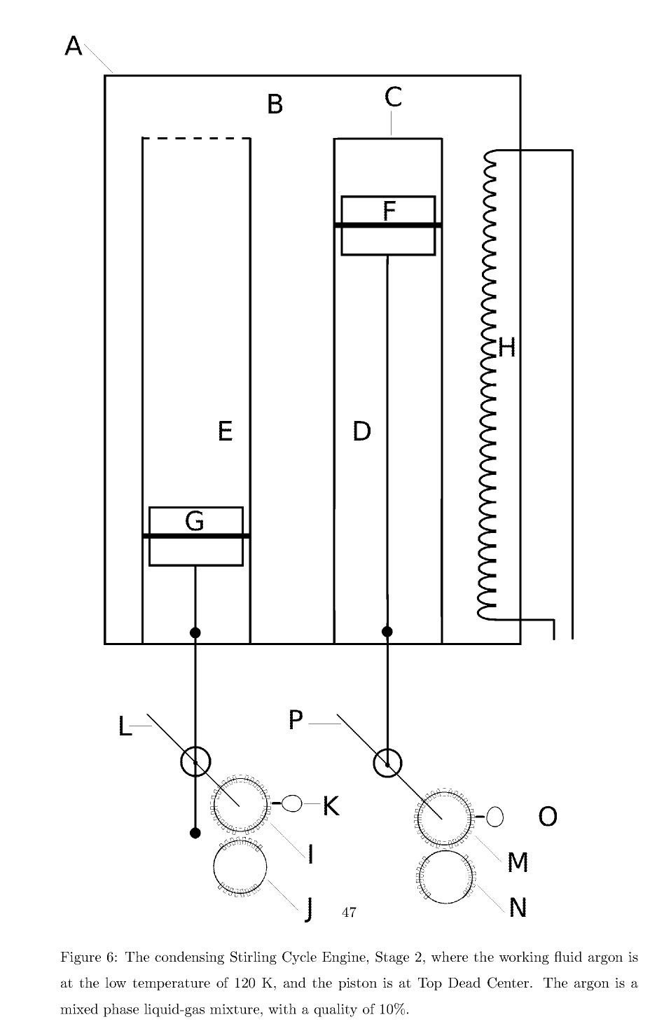

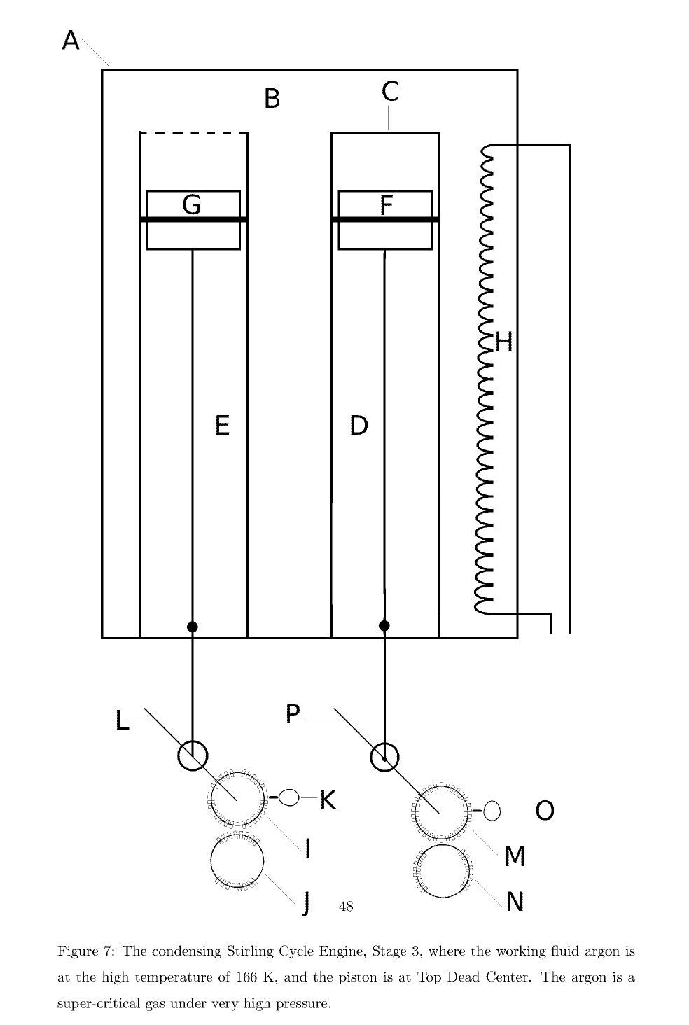

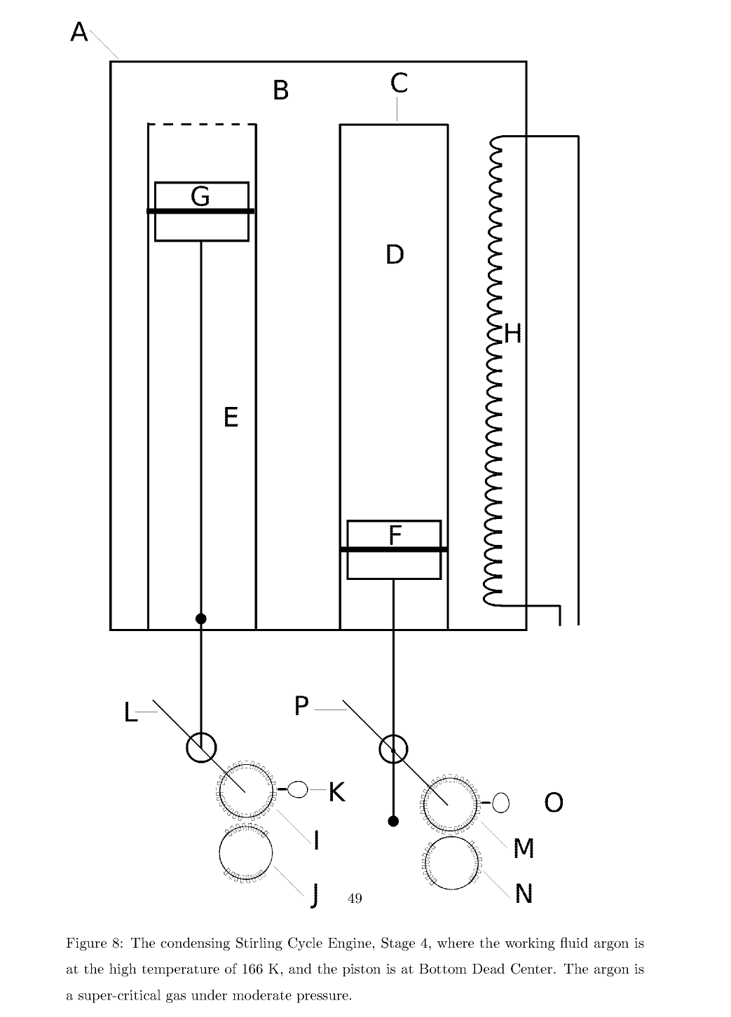

List of labeled components in FIGS. 5-10:
(A) A pressure vessel that holds an ideal gas, which by expanding and compressing will adjust the overall temperature; this example has a maximum volume compression ratio of 3.892.
(B) An ideal gas working fluid, which is to provide heat transfer to and from the condensing Stirling cycle heat engine; this example is 100 kg of air.
(C) The cylinder chamber for the condensing Stirling cycle heat engine; this example has a bore of 20 cm, a stroke of 40 cm, and a compression ratio of 6.81965.
(D) The condensing Stirling cycle heat engine working fluid; this example is a mass of 0.7575 kg of argon.
(E) The pressure vessel cylinder; the overall pressure vessel volume expands or decreases depending on the temperature of the condensing Stirling cycle heat engine.
(F) The piston for the condensing Stirling cycle heat engine.
(G) The pressure vessel piston; the piston position affects the overall volume and temperature of the ideal gas surrounding the condensing Stirling cycle heat engine.
(H) A heat exchanger for the supply fluid. During the transition from Stage 4 to Stage 2, a cold fluid at a near-constant temperature of 120 K flows through it. A valve system will direct a flow of a warmer fluid at a temperature of 166 K from Stage 2 until Stage 4.
(I) The gear that operates the pressure vessel volume piston (Part G).
(J) A mutilated gear of the same tooth size and dimensions as the gear for Part I. It has tooths in two evenly spaced sections of 90°, and no tooths for the remaining sections. It is synchronized so that there are tooths, and thus motion, for the isochoric heating Stage 23 and isochoric cooling Stage 41.
(K) A cam-shaft that is designed to activate an obstruction that locks the gear (Part I) in placed when the mutilated gear (Part J) is at a no-tooth angle. During these angles, the piston (Part G) remains fixed.
(L) The crank shaft that connects the piston (Part G) to the gear (Part I).
(M) The gear that operates the piston for the argon condensing Stirling cycle heat engine (Part F).
(N) A mutilated gear of the same tooth size and dimensions as the gear for Part M. It has tooths in two evenly spaced sections of 90°, and no tooths for the remaining sections. It is synchronized so that there are tooths, and thus motion, for the isothermal compression Stage 12 and isothermal expansion Stage 34.
(O) A cam-shaft that is designed to activate an obstruction that locks the gear (Part M) in placed when the mutilated gear (Part N) is at a no-tooth angle. During these angles, the piston (Part F) remains fixed.
(P) The crank shaft that connects the piston (Part F) to the gear (Part M).

### DETAILED DESCRIPTION OF THE INVENTION

This heat engine is a modification of the Stirling cycle, a heat engine cycle of isothermal compression at the cold temperature sink, followed by isochoric heating up to the high temperature source, followed by isothermal expansion at the high temperature back to the original volume, and ending with isochoric cooling back to the original temperature and pressure. The original Stirling cycle operated under the assumption that the working fluid was constantly an ideal gas, where the equation of state is

Pv=RT, (1)

where P (Pa) is the pressure, v (m³/kg) is the specific volume, T (K) is the absolute temperature, and R (J/kg·K) is the specific gas constant, where

$$R = \frac{{R}_{u}}{{M}_{m}} , \qquad ( 2 )$$

where Mₘ (kg/M) is the molar mass, and Rᵤ is the universal gas constant (8.314 J/M·K) defined as

Rᵤ=A·κ, (3)

where A is Avogadro's Number 6.02214.10²³, and κ is Boltzman's Constant 1.38.10⁻²³ (J/K). The number of moles M is defined as the total number of particles over Avogadro's Number

$$M = \frac{N}{A} . \qquad ( 4 )$$

The novel aspect of this engine is that it does not use an ideal gas as the working fluid, but a real gas that is subjected to condensation and evaporation. The hot temperature of the engine is above the critical temperature T_{c} (K), whereas the cold temperature of the engine is below the critical temperature, but above the triple point temperature Tₜₚ (K). The working fluid is a saturated gas at the initial, low temperature, high volume stage of the engine cycle. The working fluid partially condenses during the isothermal compression, which ends when the working fluid is a liquid-gas mixture. The working fluid is then heated isochorically to the hot temperature, upon which there is isothermal expansion back to the original stage volume, and where mechanical work is recovered. Finally, the working fluid undergoes isochoric cooling back to a saturated gas at the cool temperature, and the cycle repeats itself.

There famous Van der Waals (VDW) equation of state for a real gas is defined as

$$( P + \frac{a}{{v}^{2}} ) \cdot ( v - b ) = R \cdot T , \qquad ( 5 )$$

where a and b are the gas specifics VDW constants, where

$$a = \frac{27 \cdot {R}^{2} \cdot {T}_{c}^{2}}{64 \cdot {P}_{c}} = 3 \cdot {v}_{c}^{2} \cdot {P}_{c} , \\ b = \frac{R \cdot {T}_{c}}{8 \cdot {P}_{c}} = \frac{{v}_{c}}{3} , \qquad ( 6 )$$

where P_{c} (Pa), T_{c} (K), and v_{c} (m³/kg) are the critical pressure, temperature, and specific volume, where the first and second derivative of the pressure over volume are zero,

$${( \frac{\partial P}{\partial v} )}_{T} = {( \frac{{\partial }^{2} P}{\partial {v}^{2}} )}_{T} = 0 ,$$

and at temperatures greater than T_{c}, gas is the only possible phase of the fluid. If the specific volume is significantly greater than the critical specific volume (v>>v_{c}), then

$$\frac{a}{{v}^{2}} \approx 0 , \\ v - b \approx v , \qquad ( 7 )$$

and thus the VDW equation 5 becomes the ideal gas equation 1.

The critical pressure, temperature, and volume are material-specific, and are determined experimentally. The dimensionless reduced pressure P_{R}, temperature T_{R}, and volume v_{R} are dimensionless ratios of the pressure, temperature, and volume over the critical values

$$\begin{matrix}{P}_{R} = \frac{P}{{P}_{c}} , & ( 7 ) \\ {T}_{R} = \frac{T}{{T}_{c}} , & \\ {υ}_{R} = \frac{υ}{{υ}_{c}} . & \end{matrix}$$

The VDW equation of state can be reduced to its dimensionless state, defined as

$$( {P}_{R} + \frac{3}{{v}_{R}^{2}} ) \cdot ( {v}_{R} - \frac{1}{3} ) = \frac{8}{3} \cdot {T}_{R} , \qquad ( 8 )$$

and equation 8 can be used for an arbitrary fluid.

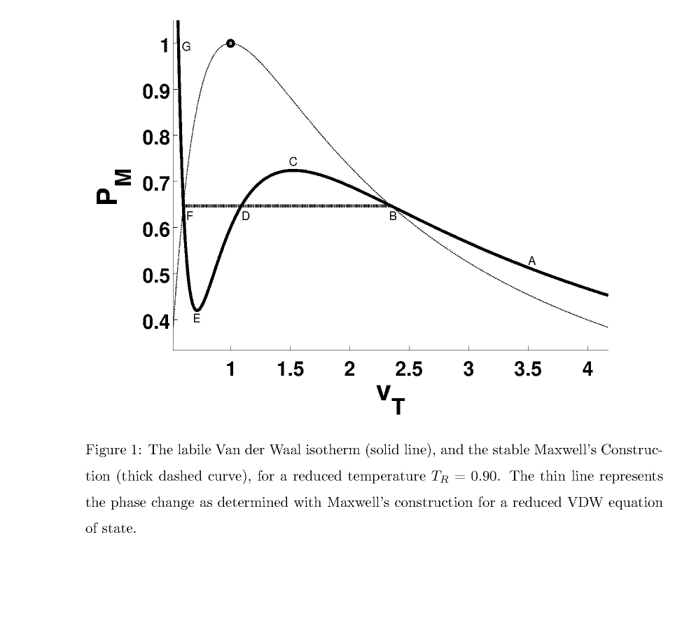

One limitation of the VDW equation of state is that they cannot be used to represent the change in the fluid from liquid to gas. Following the VDW equation of state, for a constant temperature (FIG. 1), the pressure will increase with decreasing volume, but decreasing in the rate of increase until eventually (FIG. 1-C) the pressure will decrease with decreasing volume, until it reaches an inflection point (FIG. 1-D), and eventually the decreasing pressure stops (FIG. 1-E), and the pressure increases dramatically with decreasing volume; this fluid is a liquid at this point. It is physically impossible for a stable pressure decrease with decreasing volume, and this is not observed experimentally. Once the gas is compressed isothermally to the point it is saturated, further isothermal compression will maintain a constant pressure, and the fluid will exist as two stable states of liquid and gas. The internal energy u (J/kg), enthalpy h (J/kg), entropy s (J/kg·K), and specific volume v (m³/kg) are proportional to the quality of the liquid

u=(1−χ)·u_{liquid}+χ·u_{gas},

h=(1−χ)·h_{liquid}+χ·h_{gas},

s=(1−χ)·s_{liquid}+χ·s_{gas},

v=(1−χ)·v_{liquid}+χ·v_{gas}, (9)

where χ is the mass ratio present in the stable liquid-gas state.

$$χ = \frac{{mass}_{gas}}{{mass}_{liquid} + {mass}_{gas }} .$$

This sudden change in the equation of state at the point of phase change from liquid to gas is explained with Maxwell's Construction (FIG. 1). For two phases of a fluid to remain stable together, the Gibbs Free energy G (J/kg) remains constant for both the liquid and gas state of the fluid. The Gibbs Free energy is defined as

$$\begin{matrix}G = u + P \cdot v - T \cdot s , \\ = a + P \cdot v , \\ = h - T \cdot s ,\end{matrix} \qquad ( 10 )$$

where a (J/kg) is the Helmholtz free energy. Another feature of Maxwell's Construction is that the total work applied

W=∫P·dv, (11)

from the liquid to gas phase equals the value of the VDW equation of state,

∫ᵥ_{_{liquid}}^{v}^{_{gas}}P_{VDW}·dv=P_{R}·(v_{gas}−v_{liquid}),

where P_{VDW} (Pa) is the pressure found with the VDW equation of state

$${P}_{VDW} = \frac{R \cdot T}{( v - b )} - \frac{a}{{v}^{2}} , \qquad ( 12 )$$

and the reduced pressure following the VDW equation of state is simply

$${P}_{R , VDW} = \frac{8 \cdot {T}_{R}}{( 3 \cdot {v}_{R} - 1 )} - \frac{3}{{v}_{R}^{2}} . \qquad ( 13 )$$

The values of P_{R}, v_{gas}, and v_{liquid} are determined numerically, and some reduced examples are given in Table 1.

TABLE 1
Table of reduced pressures P_{R} and specific volumes v_{R} as a function
of reduced temperature T_{R}. The reduced specific volume v_{R,x} is the
reduced volume where the reduced VDW pressure is equal to P_{R}.

| T_{R} | P_{R} | v_{R,gas} | v_{R,x} | v_{R,liquid} |
|---|---|---|---|---|
| 0.70 | 0.2461 | 6.0000 | 1.4528 | 0.4662 |
| 0.75 | 0.2825 | 5.6430 | 1.2814 | 0.4897 |
| 0.80 | 0.3834 | 4.1724 | 1.2083 | 0.5175 |
| 0.85 | 0.5045 | 3.1277 | 1.1454 | 0.5535 |
| 0.90 | 0.6470 | 2.3488 | 1.0904 | 0.6034 |
| 0.95 | 0.8119 | 1.7271 | 1.0426 | 0.6841 |
| 0.99 | 0.9605 | 1.2429 | 1.0083 | 0.8309 |
| 1 | 1 | 1 | 1 | 1 |

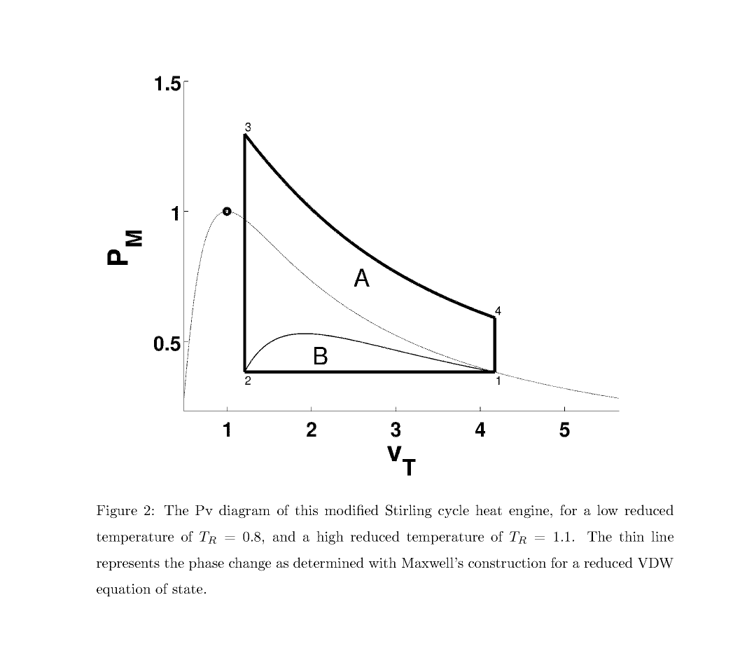

The reduced pressure-volume diagram for this heat engine has been generated in FIG. 2 for a cold reduced temperature sink of T_{R}=0.8 and a hot reduced temperature source of T_{R}=1.1. If the VDW equation of state were constantly applicable, the thin line would be the lower-temperature isotherm, and the total net work of the heat engine would be equal to the area of area A. Due to Maxwell's Construction, however, the pressure is constant when the fluid is two phases, and thus the total work output is equal to the combination of area A and B.

Many of the derivations of traditionally used thermodynamic equations are operating under the assumption that the fluid is an ideal gas. An ideal gas was used to derive the efficiency of the Carnot engine, and the entropy increase during heat transfer

$$δ s = \frac{Q}{T} , \qquad ( 14 )$$

as well as the derivation of the specific internal energy

$${u}_{ideal} = ( \frac{1}{2} + f ) R \cdot T , \qquad ( 15 )$$

where f is the number of degrees of freedom of the gas particles (f=1 for monatomic gases, f=2 for diatomic gases). Additionally, the assumption of equation 14 is used to predict the total internal energy change

$$δ u = {C}_{v} \cdot dT + \{ T \cdot {( \frac{\partial P}{\partial T} )}_{V} - P \} \cdot dv , \qquad ( 16 )$$

which can be used when the equation of state is known. It can be easily derived from equation 16 that for isothermal ideal gas compression or expansion, there is no change in internal energy or enthalpy δu=δh=0.

For this real gas bounded by the VDW equation of state and Maxwell's Construction, these ideal-gas assumptions are not valid; attempts to apply them result in an imbalance in the internal energy after completion of the internally reversible cycle, especially when there is partial condensation. Due to the kinetic theory of gas, for a monatomic gas (f=1), the pressure P (Pa) of a gas is proportional to the average velocity of each gas particle

$$\begin{matrix}P = \frac{2}{3} \cdot \frac{N \cdot {E}_{kinetic}}{V} , \\ = \frac{2}{3 \cdot v} \cdot u ,\end{matrix} \qquad ( 17 )$$

where N is the total number of particles, E_{kinetic} (J) is the average kinetic energy of each gas particle, V (m³) and v (m³/kg) is the volume and specific volume, and u (J/kg) is the specific internal energy. The internal energy U (J), by definition, is related to the average kinetic energy of the gas

U=N·E_{kinetic},

and the specific internal energy u (J/kg) is simply the total internal energy U divided by the mass. To derive equation 15 to find the specific internal energy of an ideal gas, equation 17 is plugged into the ideal gas equation 1. As this heat engine does not deal with ideal gases, but with real gases that follow VDW equation of state, the specific internal energy is derived by plugging in the definition of P from equation 5 into equation 17,

$$\begin{matrix}u = \frac{3}{2} \cdot \{ \frac{R \cdot T \cdot v}{( v - b )} - \frac{a}{v} \} , \\ = \frac{3}{2} \cdot P \cdot v ,\end{matrix} \qquad ( 18 )$$

The specific heat at a constant volume can thus be easily found as

$${C}_{v} = \frac{3}{2} \cdot \{ \frac{R \cdot v}{( v - b )} \} . \qquad ( 19 )$$

If one wants to work in terms of dimensionless reduced values, the reduced internal energy, defined as

$${u}_{R} = \frac{u}{{P}_{c} \cdot {v}_{c}} , \qquad ( 20 )$$

can be found with a reduced version of equation 18

$$\begin{matrix}{u}_{R} = \frac{3}{2} \cdot \{ \frac{8 \cdot {T}_{R} \cdot {v}_{R}}{( 3 \cdot {v}_{R} - 1 )} - \frac{3}{{v}_{R}} \} \\ = \frac{3}{2} \cdot {P}_{R} \cdot {v}_{R} ,\end{matrix} \qquad ( 21 )$$

The reduced specific heat at a constant volume is simply the reduced temperature derivative of equation 21

$${C}_{V , R} = \frac{3}{2} \cdot \{ \frac{8 \cdot {v}_{R}}{( 3 \cdot {v}_{R} - 1 )} \} . \qquad ( 22 )$$

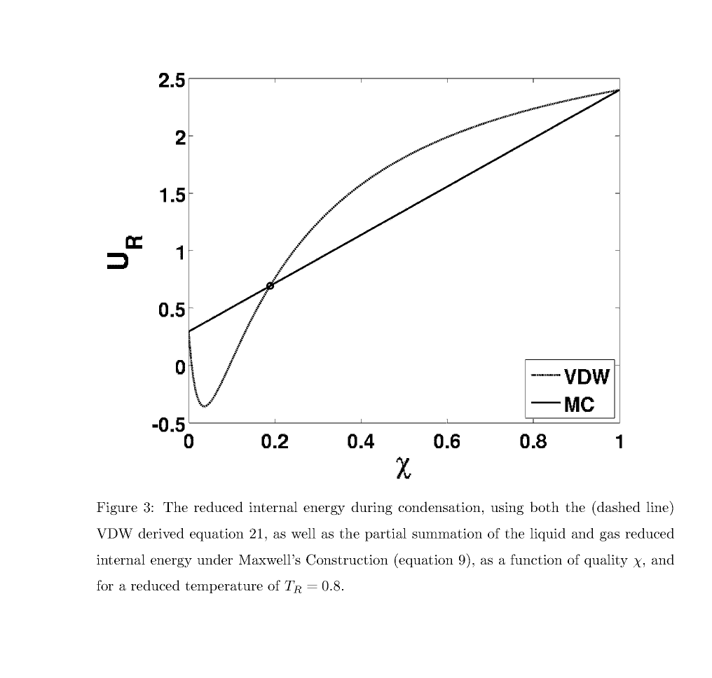

One observed phenomenon of Maxwell's Construction is the fact that when there are two phases in stable equilibrium, the internal energy initially decreases more for a given reduction in volume, than what would be calculated with equation 18 and 21 for a single phase of the same temperature and specific volume. This phenomenon is demonstrated in FIG. 3 for a reduced temperature T_{R}=0.8; the difference in internal energy, and thus difference in entropy, is greatest when the distinction between the two phases is maximized In addition, during the condensation, it is clear from qualitative observation that there is less mixing, disorder, and randomness between the fluid particles when they are segregated between one of two distinct phases. Because of these facts, it can be realized that the act of mixed phases as described by Maxwell's Construction results in a greater decrease in entropy, as compared to the decrease in entropy that would occur if the fluid consistently followed the same VDW equation of state and the gas was compressed isothermally into a labile super-saturated gas.

A demonstration was conducted of the condensing Stirling cycle heat engine demonstrated in FIG. 2, with a low reduced temperature of T_{R}−0.8 and a high reduced temperature of T_{R}=1.1. The working fluid is assumed to be monatomic (f=1), such as Helium, Neon, Argon, Krypton, Xenon, or Radon. According to Table 1, for a reduced temperature of T_{R}=0.8, the saturated liquid and gas have a reduced volume of 0.5175 and 4.1724, respectively; the reduced pressure is 0.3834. If Maxwell's Construction did not apply, and the VDW equation of state was consistent, a reduced volume of 1.2083 at a quality of 0.1890 would yield the same reduced pressure, as well as the saturated liquid and gas reduced volumes.

The condensing Stirling cycle heat engine is a moving boundary cycle, as seen in a piston-cylinder system. At Stage 1 and Stage 4, the piston is at Bottom Dead Center (BDC), and the reduced volumes are the saturated gas reduced volume (v_{R}=4.1724); whereas Stage 2 and Stage 3, the piston is at Top Dead Center (TDC), and the reduced volume is the equivalent volume when the VDW pressure equals the reduced pressure v_{R}=1.2083. The reduced temperatures at Stage 1 and 2 are low (T_{R}=0.8), whereas at Stage 3 and 4 the reduced temperatures are high (T_{R}=1.1). The reduced pressures P_{R} are found with equation 8, whereas the reduced internal energy u_{R} was found with equation 21. The results of the cycle are in Table 2.

TABLE 2
The reduced pressure P_{R}, reduced temperature T_{R}, reduced volume
v_{R}, reduced internal energy u_{R}, and reduced enthalpy h_{R} data values
of the condensing Stirling cycle heat engine demonstrated in FIG. 2,
with a low reduced temperature of T_{R} = 0.8 and a high reduced
temperature of T_{R} = 1.1.

| Stage | P_{R} | T_{R} | v_{R} | u_{R} | h_{R} |
|---|---|---|---|---|---|
| 1 | 0.38336 | 0.8 | 4.1724 | 2.3993 | 3.9989 |
| 2 | 0.38336 | 0.8 | 1.2083 | 0.6936 | 1.1568 |
| 3 | 1.2977 | 1.1 | 1.2083 | 2.352 | 3.92 |
| 4 | 0.59175 | 1.1 | 4.1724 | 3.7035 | 6.1725 |

With the change of each stage in this cycle, there is some heat exchanged with the ambient universe, as well as a work applied when there is a moving boundary. The first law of thermodynamics states that energy can not be created or destroyed, and that the change in internal energy equals the heat and work input into the working fluid,

δuᵢⱼ=Qᵢⱼ−Wᵢⱼ, (23)

where δuᵢⱼ (J/kg) is the change in internal energy, Qᵢⱼ (J/kg) is the heat transferred, and Wᵢⱼ (J/kg) is the work applied across the boundary, from stage i to j. As the pressure is constant during the isothermal compression with partial condensation, the reduced work input from Stage 1 to 2 is simply

$$\begin{matrix}{W}_{R , 12} = {P}_{R} \cdot ( {v}_{R , gas} - {v}_{R , x} ) , \\ = 0.3834 \cdot ( 4.1724 - 1.2083 ) \\ = 1.1363 ,\end{matrix}$$

where reduced work is defined as the work (J/kg) divided by the product of the critical pressure and critical temperature, similar to equation 20

$${W}_{R} = \frac{W}{{P}_{c} \cdot {v}_{c}} . \qquad ( 24 )$$

The reduced work applied across the boundary can be found by integrating the VDW pressure, defined in equation 13, plugged into equation 11,

$$\begin{matrix}{W}_{R , 34} = {\int }_{{v}_{R 3}}^{{v}_{R 4}} \{ \frac{8 \cdot {T}_{R}}{( 3 \cdot {v}_{R} - 1 )} - \frac{3}{{v}_{{R}^{2}}} \} d {v}_{R} , \\ = {\{ \frac{8}{3} \cdot {T}_{R} \cdot log ( {v}_{R} - \frac{1}{3} ) + \frac{3}{{v}_{R}} \}}_{{v}_{R 3}}^{{v}_{R 4}} , \\ = - 2.5740 .\end{matrix}$$

The change in reduced internal energy is found by taking the difference in internal energy at each stage, determined with equation 21. Finally, the value of the heat transfered during each stage is found with the first law of thermodynamics equation 23. These results are tabulated in Table 3. It can be noted that the summation of the heat and work changes is equal to zero, as this is an internally reversible cycle.

What is interesting about this engine cycle is the entropy change of the universe (Table 4) for each phase of the cycle, when entropy is determined with equation 14, which was determined for the ideal Carnot cycle, which assumes an ideal gas equation of state (equation

TABLE 3
Heat and work changes between each stage during the condensing
Stirling cyle heat engine demonstrated in FIG. 2, with a low reduced
temperature of T_{R} = 0.8 and a high reduced temperature
of T_{R} = 1.1. The summation of the heat and work changes in
this table is equal to zero.

| Stage | 12 | 23 | 34 | 41 |
|---|---|---|---|---|
| Q | −2.8420 | 1.6584 | 3.9255 | −1.3042 |
| W | 1.1363 | 0 | −2.5740 | 0 |

1). For the isothermal compression and expansion stages, these are easily determined,

$$δ {s}_{12} = - \frac{{Q}_{12}}{{T}_{12}} = \frac{2.8420}{0.8} = 3.5526 , \\ δ {s}_{34} = - \frac{{Q}_{34}}{{T}_{34}} = - \frac{3.9255}{1.1} = - 3.5686 .$$

The reduced constant specific heat of a constant volume is determined with equation 22

$${C}_{V , 41} = \frac{3}{2} \cdot \{ \frac{8 \cdot {v}_{R , gas}}{3 \cdot {v}_{R , gas} - 1} \} = \frac{3}{2} \cdot ( \frac{8 \cdot 4.1724}{3 \cdot 4.1724 - 1} ) = 4.3473 ,$$

and C_{v,41} can be used to find the equivalent entropy change out of the universe during stage 41,

$$δ {s}_{41} = - {\int }_{{T}_{4}}^{{T}_{1}} \frac{{C}_{V} \cdot d T}{T} = {C}_{V} \cdot log ( \frac{{T}_{4}}{{T}_{1}} ) = 4.3473 \cdot log ( \frac{1.1}{0.8} ) = 1.3844 .$$

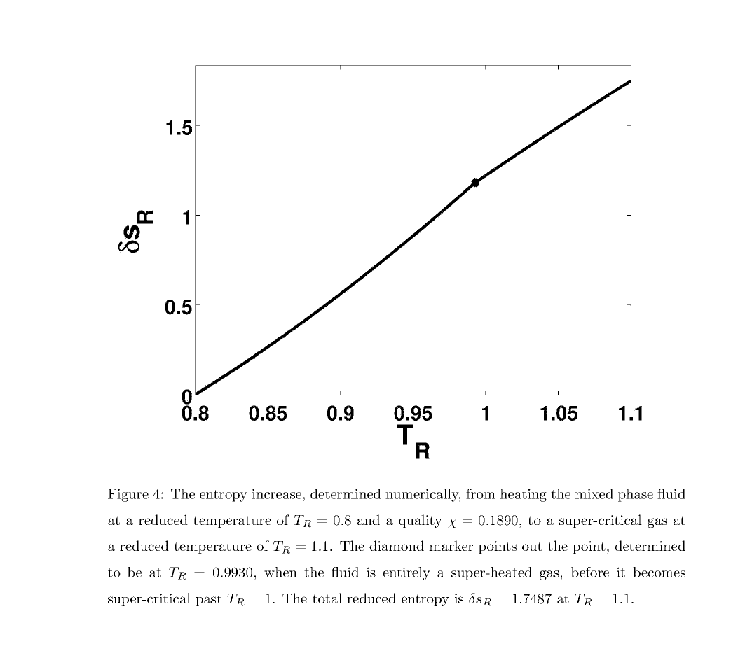

Because of Maxwell's Construction, the entropy change during stage 2-3 had to be determined numerically until the fluid was a single-phase super-heated gas. At each subsequent reduced temperature increment, the saturated liquid and gas reduced volumes are found numerically with Maxwell's Construction, the quality is determined as the volume is held constant during the heating, and then the cumulative internal energy is found as the summation of the liquid and gas reduced internal energies (equation 9). The gas becomes super-heated after T_{R}=0.9930, and then the reduced internal energy increase is found the same way as δs₄₁. The change in entropy is determined by finding the change in internal energy for each temperature increment, and dividing by the reduced temperature. When heating a two-phase fluid from T_{R}=0.8 to a super-critical gas at T_{R}=1.1 at a constant reduced volume of v_{R}=1.2083, the entropy increase is demonstrated in FIG. 4, and the total reduced entropy increase is δs₂₃=1.7487.

TABLE 4
The change in reduced entropy to the universe, calculated with
equation 14, for each stage of the condensing Stirling cycle heat
engine demonstrated in FIG. 2, with a low reduced temperature of
T_{R} = 0.8 and a high reduced temperature of T_{R} = 1.1.
The entropy in Stage 23 cannot be calculated analytically; it was
solved numerically, and the reduced entropy increase as a function
of reduced temperature can be found in FIG. 4.

| S12 | S23 | S34 | S41 | Snet |
|---|---|---|---|---|
| 3.5526 | −1.7487 | −3.5686 | 1.3844 | −0.3803 |

In ideal heat transfer, where the difference in temperature is kept to a minimum, the summation of the entropy changes out of the known universe

−(δs₁₂+δs₂₃δs₃₄δs₄₁)_{R}=δsₙₑₜ

3.5526−1.7487−3.5686+1.3844=−0.3803.

is observed to be negative. This phenomenon is observed for real gases; when the specific volume is expanded significantly (reducing the influence of intermolecular attractive forces) to simulate ideal gases, the net-total entropy goes to zero. This phenomenon can be observed by the fact that the heat engine efficiency,

$$\begin{matrix}η = \frac{{W}_{net}}{{Q}_{i n}} , \\ = \frac{{W}_{12} + {W}_{34}}{{Q}_{34} + {Q}_{23} - {Q}_{41}} = 0.3359 ,\end{matrix} \qquad ( 25 )$$

exceeds the ideal-gas Carnot efficiency,

$$\begin{matrix}{η}_{C} = 1 - \frac{{T}_{L}}{{T}_{H}} , \\ = 1 - \frac{0.8}{1.1} = 0.2727 ,\end{matrix} \qquad ( 26 )$$

This reduction in ideal-gas entropy is increased due to Maxwell's Construction and mixed-phase condensation; the reduced pressure and work input to compress the gas results in less heat transfer out and thus less entropy generated to the surrounding universe. Of course, this does not encompass the real losses, as heat transfer has to have a temperature gradient, and there is some irreversible loss from friction. Nevertheless, under ideal conditions, the condensing Stirling cycle heat engine demonstrated in FIG. 2, with a low reduced temperature of T_{R}=0.8 and a high reduced temperature of T_{R}=1.1, can have a theoretical reduction in total entropy within the universe; while heat transfer flows consistently from hot to cold, consistent with the second law of thermodynamics.

The first law of thermodynamics, described in equation 23, is consistently observed, as everything, including energy, comes from somewhere. The second law of thermodynamics can be ascribed as the fact that heat can only flow from hot to cold, thus increasing the overall disorder during heat transfer. The fact that in a natural process heat transfer only flows from hot to cold has consistently been observed, and is therefore a law of nature.

How can this condensing Stirling cycle heat engine be reconciled with the second law of thermodynamics? This can be explained by the fact that the reduction in overall entropy is observed near the point of condensation, when the intermolecular attractive forces are profound due to the fluid molecules being in close proximity. During the isothermal compression, these intermolecular forces seek to pull the gas molecules together, in effect generating order with less work input by the boundary piston. By removing the intermolecular force component a from the equation of state, which effectively happens when the specific volume is increased and the fluid becomes an ideal gas, there is no reduction in net entropy. For this reason, this condensing Stirling cycle heat engine can reduce the net overall entropy in the universe without violating the first and second law of thermodynamics.

The condensing Stirling cycle heat engine described so far has been a theoretical cycle following a reduced VDW equation of state. The real engine that the inventor claims is a piston-cylinder system with the monatomic fluid argon; the engine cycle can work with any monatomic fluid if sized and designed accordingly. Argon was selected because helium and neon have extremely low critical temperatures of 5 K and 44 K; this cycle utilizes a cold temperature sink colder than the critical temperature. The heavier monatomic fluids of Krypton, Xenon, and Radon have higher critical temperatures of 209 K, 289 K, and 377 K, but their expense and rarity would make them infeasible to be a practical working fluid in this engine. For this reason, argon was selected as the best practical working fluid.

In addition, while the VDW equation of state is often a reasonable representation of molecular behavior, it is still fairly inaccurate when compared to experimental measurements. There are numerous equations of states for different molecules, and they are constantly evolving to better fit new experimental data. For the purpose of this design, the tables in Thermodynamic Properties of Argon from the Triple Point to 1200 K with Pressures to 1000 MPa by Stewart and Jacobsen 1989 (DOI: 10.1063/1.555829) will be used.

To best represent the theoretical condensing Stirling cycle heat engine demonstrated in FIG. 2, with a low reduced temperature of T_{R}=0.8 and a high reduced temperature of T_{R}=1.1, argon will be used with a low temperature T_{L} of 120 K, and a high temperature T_{H} of 166 K; the critical temperature of argon is 150.6633 K. At the critical point, the pressure 4.860 MPa, and the density is 13.29 mol/dm³; with a molar mass of 39.948 g/mol, the density can be converted to 530.9 kg/m³.

At Stage 1 of this cycle, the fluid is a saturated gas at the low temperature of 120 K; according to the referenced tables, the pressure is 1.2139 MPa, and the saturated liquid and gas densities are 29.1230 mol/dm³ and 1.5090 mol/dm³. The densities can easily be converted to the specific volumes, which are 0.8595.10⁻³ m³/kg and 16.5888.10⁻³ m³/kg for saturated liquid and gas argon at 120 K. This engine will compress the fluid to a quality χ of 10%, and therefore the volume is

$$\begin{matrix}{v}_{2} = χ \cdot {v}_{gas} + ( 1 - χ ) \cdot {v}_{liquid} \\ = ( 0.1 \cdot 16.5888 \cdot {10}^{- 3} ) + ( 0.9 \cdot 0.8595 \cdot {10}^{- 3} ) \\ = 2.4325 \cdot {10}^{- 3} .\end{matrix} \qquad$$

This corresponds to a density of 10.2910 mol/dm³.

The hot, super-critical portion of the engine cycle will occur at a consistent temperature of 166 K, as the specific volume expands isothermally from 2.4325.10⁻³ m³/kg to the 120 K saturated gas specific volume of 16.5888.10⁻³ m³/kg. Referencing Table 5, the pressures and densities at 166 K can be determined, and the work output during isothermal expansion is calculated with the numerical summation of equation 11

$$\begin{matrix}{W}_{34} = {\sum }_{n = 2}^{8} \frac{( {P}_{n} + {P}_{n - 1} )}{2} \cdot ( {v}_{n} - {v}_{n - 1} ) \\ = - 48.8763 ( kJ \text{/} kg ) .\end{matrix}$$

The work input during isothermal compression with condensation is more easily calculated, as due to Maxwell's Construction, the pressure remains constant,

$$\begin{matrix}{W}_{12} = {P}_{12} \cdot ( {v}_{1} - {v}_{2} ) \\ = 1.2139 \cdot ( 16.5888 - 2.4325 ) \\ = 17.1844 ( kJ \text{/} kg ) ,\end{matrix}$$

and thus the net mechanical work out of this engine per unit mass of working fluid for each cycle is -31.6919 kJ/kg.

TABLE 5
Table of Argon at 166 K. The values for data point 1 were determined
by interpolation between the values of data point 2 and *; likewise
the values for data point 8 were determined by interpolation between
the values of data point 7 and x.

| i | P (MPa) | Density (mol/dm³) | v · 10⁻³ (m³/kg) |
|---|---|---|---|
| * | 1.5 | 1.1822 | 21.1745 |
| 1 | 1.8669 | 1.5090 | 16.5888 |
| 2 | 2.0000 | 1.6275 | 15.3810 |
| 3 | 2.5000 | 2.1058 | 11.8874 |
| 4 | 3.0000 | 2.6235 | 9.5417 |
| 5 | 4.0000 | 3.8140 | 6.5633 |
| 6 | 5.0000 | 5.3102 | 4.7140 |
| 7 | 6.0000 | 7.3273 | 3.4163 |
| 8 | 6.9007 | 10.2910 | 2.4325 |
| x | 8 | 13.9080 | 1.7999 |

It is now possible to characterize the pressure, temperature, specific volume, internal energy, and enthalpy of the condensing Stirling cycle heat engine with argon. The pressures are determined from the referenced tables; the pressure of condensation for T=120K of P₁−P₂−1.2139 MPa, and the interpolated super-critical pressures of P₃−6.9007 MPa and P₄=1.8689 MPa. The temperatures are by design, with T₁=T₂=120 K and T₃−T₄−166 K. The specific volumes are designed by the piston and cylinder, with the Top Dead Center volume of v₂=v₃=2.4325.10⁻³ (m³/kg), and the Bottom Dead Center volume of v₁=v₄=16.5888.10⁻³ (m³/kg). The internal energy u and enthalpy h are determined from the kinetic gas theory (equation 18), which for a monatomic fluid such as argon,

$$u = \frac{3}{2} \cdot P \cdot v , \\ h = \frac{5}{2} \cdot P \cdot v .$$

and thus the results can be found in Table 6.

TABLE 6
Table of Argon Pressure P, Temperature T, specific volume v,
internal energy u, and enthalpy h.

| P | T | v · | u | h |
|---|---|---|---|---|
| (MPa) | (K) | 10⁻³ (m³/kg) | (kJ/kg) | (kJ/kg) |
| 1.2139 | 120 | 16.5888 | 30.2058 | 50.3429 |
| 1.2139 | 120 | 2.4325 | 4.4292 | 7.3819 |
| 6.9007 | 166 | 2.4325 | 25.1787 | 41.9645 |
| 1.8669 | 166 | 16.5888 | 46.4556 | 77.4260 |

Next, the first law of thermodynamics is used to determine the heat input and output at each stage. The work applied during isothermal compression and expansion has been determined, and the heat input is simply the summation of the change in internal energy minus the work applied by the fluid (equation 23)

Qᵢⱼ=δuᵢⱼWᵢⱼ,

and thus using the internal energies in Table 6, the net heat inputs and outputs can be determined and included in Table 7. The summation of the heat and work in Table 7 is zero,

Eᵢⱼ(Q+W)ᵢⱼ=−42.961+20.7496+70.1532−16.2498+17.1844−48.8764=0,

showing that this cycle is an internally reversible cycle that complies with the first law of thermodynamics.

TABLE 7
Table of heat and work inputs and outputs at each stage of the
argon condensing Stirling cycle heat engine.

| — | 12 | 23 | 34 | 41 |
|---|---|---|---|---|
| Q (kJ/kg) | −42.9610 | 20.7496 | 70.1532 | −16.2498 |
| W (kJ/kg) | 17.1844 | 0 | −48.8764 | 0 |

Finally, the efficiency η of this engine

$$η = \frac{{W}_{net}}{{Q}_{i n}} ,$$

can be determined from the values in Table 7

$$η = - \frac{{W}_{12} + {W}_{34}}{{Q}_{23} + {Q}_{34}} = \frac{48.8764 - 17.1844}{20.7496 + 70.1532} = \frac{31.6920}{90.9028} = 0.3486 .$$

If there is perfect regeneration of the heat output from the isochoric cooling (41) into the heat input from the isochoric heating (23), the efficiency is improved

$${η}_{regen} = - \frac{{W}_{12} + {W}_{34}}{{Q}_{23} + {Q}_{34} + {Q}_{41}} = \frac{48.8764 - 17.1844}{20.7496 + 70.1532 - 16.2498} = \frac{31.6920}{74.6530} = 0.4245 .$$

Remarkably, both of these values are greater than the Carnot efficiency

$${η}_{C} = 1 - \frac{{T}_{L}}{{T}_{H}} = 1 - \frac{120}{166} = 0.2771 ,$$

and this efficiency that exceeds the Carnot efficiency is evidence that the intermolecular attractive forces are reducing the disorder of the molecules during the isothermal compression with condensation.

An example of this engine cycle being practically implemented is represented in FIGS. 5-10. The engine is a sealed piston, of 20 cm bore and 40 cm stroke, and filled with 0.7575 kg of argon. This piston is surrounded by an ideal gas under pressure in a sealed pressure vessel, and the heat exchanger supplies both heating and cooling fluids to the surrounding ideal at the temperatures of 120 K and 166 K. The heat transfer of the argon filled piston shall be efficient enough that the temperature of the argon will be nearly identical to the temperature of the surrounding gas.

The pressure vessel volume can expand and contract by an isentropic piston; this piston recovers mechanical energy during expansion and inputs mechanical energy during compression. During the isochoric heating of the argon, the volume of the surrounding ideal gas will compress slowly so that the ideal gas will heat up slowly, and the temperature difference during heat transfer will be minimized, reducing the overall entropy of heat transfer of the engine cycle. A mechanical work input will be used during this compression; this work will be recovered when the piston expands while the argon is undergoing isochoric cooling.

For the practical implementation of the argon engine described, 100 kg of air will be used as the surrounding heat transfer fluid; air has a specific heat ratio of 1.4 and a gas constant of 287 J/kg·K. The pressure vessel can be of an arbitrary volume; for the given mass, decreasing the volume will result in an increase in pressures, but not affecting the work inputs and outputs. For 100 kg of air, 0.7575 kg of argon, and a temperature range between 120 K and 166 K, the ideal gas volume decreases by a factor of 3.892, and the work input for each compression stroke would be 3.3162 megajoules. This compression will serve to raise the temperature from 120 K to 166 K, and allow for sufficient heat loss to heat the argon simultaneously. This energy is recovered during the argon cooling stage, where the piston expands and recovers this energy. By using this method, reducing the temperature difference significantly during heat transfer, the ideal engine efficiency (excluding friction and irreversible losses) can even exceed the minimum predicted 34.86% and get closer to the 42.45% possible with this engine cycle.

The pistons are synchronized, so that the ideal gas piston is fixed when the argon engine piston is in motion, and vice versa. During the isothermal compression of the argon, the heat input into the ideal gas is removed by the heat exchanger fluid (at 120 K), and the ideal gas piston remains fixed at Bottom Dead Center. During the isochoric heating, the heat exchanger fluid ceases to flow, the argon piston is held fixed, and the ideal gas piston compresses the gas to Top Dead Center. For the isothermal expansion of the argon, the ideal gas piston remains fixed at Top Dead Center, and the heat exchanger fluid flowing provides a source of heat at 166 K. Finally, the argon gas is held fixed by the piston, while the gas cools to saturation; during this time the ideal gas piston is expanding back to Bottom Dead Center and recovering mechanical energy.

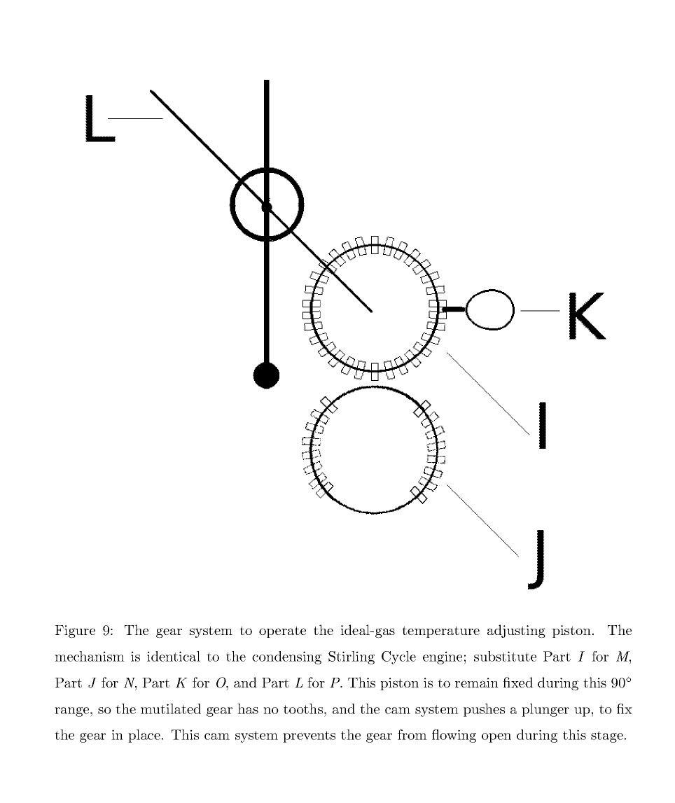

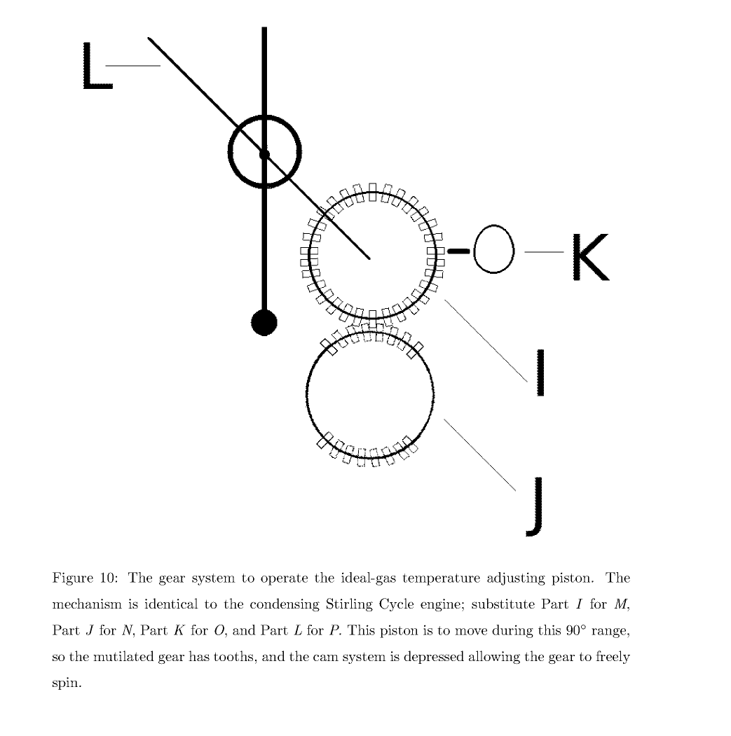

To synchronize these two pistons, each piston is controlled by a gear, which is operated by a mutilated gear. These two mutilated gears have teeth on half of the circumference, divided into four 90° sections of gear-teeth and no-gear-teeth. These gears are connected to a cam-shaft, that operates a brake that holds the piston fixed in place during the no-gear-teeth angles; without this feature, the pressurized ideal and argon gas will expand against the piston prematurely. FIG. 9 represents the no-gear-teeth angles, when the piston is locked in place. FIG. 10 represents the gear-teeth angles, where the cam shaft releases the brake, and the piston is free to move. Both the ideal gas piston and the argon piston are connected to the same constant-speed crank-shaft where mechanical energy is recovered from the heat engine; the two pistons are offset by 90° so that the two pistons are not in motion at the same time.

This cycle can run at varying speed so long as it is slow enough to ensure sufficient heat transfer at each stage. The greater and more consistent the heat transfer, the less entropy will generate and thus the efficiency of the heat engine will increase. With sufficient heat transfer, and a temperature source and sink of 120 K and 166 K, heat engine efficiencies in excess of the 27.71% Carnot efficiency can be achieved by taking advantage of the attractive intermolecular forces during condensation.

What I claim is:

1. A method of operating a mechanical heat engine according to an internally reversible, thermodynamic cycle, comprising:
providing a saturated, sub-critical temperature, gas in a piston-cylinder system at bottom dead center;
isothermally compressing the saturated gas in the piston-cylinder system to a mixed-phase liquid-gas mixture at top dead center;
isochorically heating the fluid in the piston-cylinder system to a super-critical temperature at top dead center;
isothermally expanding the high-pressure super-critical gas to bottom dead center; and
isochorically cooling the gas in the piston-cylinder system back to the saturated gas initial state of the piston at bottom dead center at the sub-critical temperature.

2. A method of reducing the work input during isothermal compression due to the intermolecular attractive forces of the fluid.

3. A method of reducing entropy of heat transfer by isentropically compressing and expanding the volume of the surrounding ideal gas to raise and lower the surrounding temperature gradually;
the isentropic compression raises the temperature of the surrounding fluid without an increase in entropy, as well as;
the isentropic expansion lowers the temperature of the surrounding fluid without an increase in entropy, resulting in;
heat transfer to the object of interest at a much lower temperature gradient, resulting in less net entropy from the heat transfer, and increasing the overall engine efficiency.

4. The method of claim 2, by taking advantage of the intermolecular attractive forces during condensation of a sub-critical temperature fluid from a saturated gas to a mix-phased fluid;
the theory of Maxwell's Construction will keep the pressure constant during condensation, rather than allow the pressure to rise with reduced volume, and thus allowing a reduction in work input.

5. The mechanical heat engine of claim 1, taking advantage of the method of claim 2 and claim 4, where the intermolecular attractive forces of the working fluid reduces the work input during the isothermal compression with condensation from a sub-critical saturated gas to a mixed-phase fluid, and increasing the heat engine efficiency.

6. The mechanical heat engine of claim 1, using a monatomic working fluid to improve thermodynamic efficiency.

7. The mechanical heat engine of claim 1, using argon as the monatomic working fluid as described in claim 6, to take advantage of its availability and practical critical temperature.

8. The mechanical heat engine of claim 1, using the monatomic gas argon described in claim 6 and claim 7:
operating within a temperature range of 120 K and 166 K; and
operating with a density range of 1.5090 and 10.2910 mol/dm²; and
operating with an ideal thermodynamic efficiency of 34.86% without regeneration, due to;
the enhanced efficiency resulting from the intermolecular attractive forces of the argon during isothermal compression with partial condensation, as described in claim 2 and claim 4.

9. The mechanical heat engine of claim 8, utilizing a piston-cylinder system with a bore of 20 cm, a stroke of 40 cm, a compression ratio of 6.81965, and 0.7575 kg of argon.

10. A method of heating and cooling the mechanical heat engine in claim 1 during the isochoric heating and cooling stages by the method of claim 3, isentropically compressing and expanding ideal gas within an adjustable volume pressure vessel that is proximate the mechanical heat engine.

11. An adjustable volume pressure vessel as described in claim 10 used to heat and cool the engine in claim 9 during the isochoric heating and cooling stages by compressing 100 kg of air to a density 3.892 greater than the original density; where
the energy to compress the air is 3.3 megajoules; and
this energy is recovered when the air expands back to the original pressure vessel volume while the argon heat engine in claim 8 is undergoing isochoric cooling.
